(19) United States
(12) Patent Application Publication
(10) Pub. No.: US 2014/0175805 A1
(43) Pub. Date: Jun. 26, 2014

(54) DRIVE ASSEMBLY

(71) Applicant: Alexander Fothergill, Exbury (GB)

(72) Inventor: Alexander Fothergill, Exbury (GB)

(21) Appl. No.: 14/233,805

(22) PCT Filed: Jul. 19, 2012
(86) PCT No.: PCT/GB2012/051727

§ 371 Date: Mar. 12, 2014

(30) Foreign Application Priority Data
Jul. 21, 2011 (GB) 1112547.3

(51) Int. Cl. H02K 7/00; B61B 13/00

(52) U.S. Cl. CPC H02K 7/006; B61B 13/00
USPC 290/1 A; 104/287

(57) ABSTRACT

A drive assembly for providing a driving force to generate electricity. The assembly includes: a first track declined in a first direction through a first declination; a second track having a first portion which extends in a second direction in a substantially horizontal configuration, and a second portion which is arranged to pivot with respect to the first track between a first position in which the second portion is substantially coincident with the first portion and a second position in which the second portion is declined in the second direction through a second declination; a drive shaft which is coupled to first and second vehicles, the drive shaft being arranged to rotate in dependence of the travel of the first and second vehicles along the respective tracks. The first vehicle is arranged to travel along the first track between a first drive location and a first idle location to drive the shaft in a first direction and to cause the second vehicle to travel along the first portion of the second track between a second idle location and a second drive location; and, the second vehicle is arranged to travel along the second portion from the second drive location to the second idle location to cause the drive shaft to rotate in a second direction and to cause the first vehicle to travel from the first idle location to the first drive location.

The present invention relates to a drive assembly.

The rapidly depleting sources of fossil fuels and the harmful environmental effects associated with their use, is well-documented. As a result, there is an increasing effort to provide energy, namely electricity, from renewable sources in an attempt to prevent further damaging the environment.

In accordance with the present invention as seen from a first aspect, there is provided a drive assembly for providing a driving force, the assembly comprising:
a first track along which a first vehicle is arranged to travel, the first track being declined in a first direction through a first declination;
a second track along which a second vehicle is arranged to travel, the second track comprising a first portion which extends in a second direction in a substantially horizontal configuration, and a second portion which is arranged to pivot with respect to the first track between a first position in which the second portion is substantially coincident with the first portion and a second position in which the second portion is declined in the second direction through a second declination;
a drive shaft coupled to the first and second vehicle, the drive shaft being arranged to rotate in dependence of the travel of the first and second vehicles along the respective tracks; wherein,
the first vehicle is arranged to travel along the first track between a first drive location and a first idle location to drive the shaft in a first direction and to cause the second vehicle to travel along the first portion of the second track between a second idle location and a second drive location; and,
the second vehicle is arranged to travel along the second portion from the second drive location to the second idle location to cause the drive shaft to rotate in a second direction and to cause the first vehicle to travel from the first idle location to the first drive location.

Advantageously, the drive assembly provides for a rotational drive to a drive shaft through the interaction of a first and second vehicle which are arranged to move to drive the shaft into rotation.

The second vehicle is preferably arranged to extend from the second drive location when the second portion is arranged in the second position and the second portion is preferably arranged to pivot from the second position to the first position as the second vehicle travels along the second portion.

The second portion of the second track is preferably biased, for example by a coil spring, to the first position, in which the second portion is substantially coincident with the first portion.

Preferably, the assembly further comprises a return drive for reconfiguring the second portion from the first position to the second position. The return drive is preferably driven by a fluid flow, such as a river flow or waves on the sea and thus relies upon a renewable energy source to reset the drive assembly for further driving of the drive shaft. The return drive preferably comprises a first and second drive unit which separately comprise a belt or chain and sprocket arrangement. The belt, for example of the first drive unit is releasably coupled to a floatation device via a coupling arrangement, and the floatation device is preferably arranged to rise and fall in accordance with the fluid flow, to drive the belt of the first drive unit. The floatation device is preferably arranged to drive the belt of the first drive unit during a rise and fall of the floatation device.

The coupling arrangement preferably comprises a first coupler which is arranged to couple with the belt at a first side of the first drive unit, to drive the belt as the flotation device rises with the fluid flow and to release the belt as the flotation device falls with the fluid flow. The coupling arrangement further comprises a second coupler which is arranged to couple with the belt at a second side of the first drive unit to drive the belt as the flotation device falls with the fluid flow and to release the belt as the flotation device rises with the fluid flow.

The second drive unit is preferably arranged to be driven by the first drive unit and comprises a drive projection disposed on the belt or chain thereof, which is arranged to engage the second portion to drive the second portion from the first position to the second position as the second vehicle travels from the second idle position to the second drive position, and to disengage from the belt or chain as the vehicle travels along the second portion from the second drive position to the second idle position.

The first and second vehicles are preferably coupled to the drive shaft by a respective first and second belt, chain or tether, or similar. The drive shaft preferably comprise a first wheel which is rotatably coupled thereto, about which the first tether is arranged to retractably extend and a second wheel which is rotatably coupled thereto, about which the second tether is arranged to retractably extend.

The first and second wheels may be rotatably coupled to the drive shaft via a gear to provide for a variable rotation of the drive shaft compared with the rotation of the first and/or second wheels.

Preferably, the first and second tracks extend in the same plane and the first and second directions are substantially opposite directions.

The drive shaft may be arranged to drive an electric generator to generate electricity.

In accordance with the present invention as seen from a second aspect there is provided a method of generating electricity, the method comprising the use of the drive assembly of the first aspect.

An embodiment of the present invention will now be described by way of example only and with reference to the accompanying drawings in which:

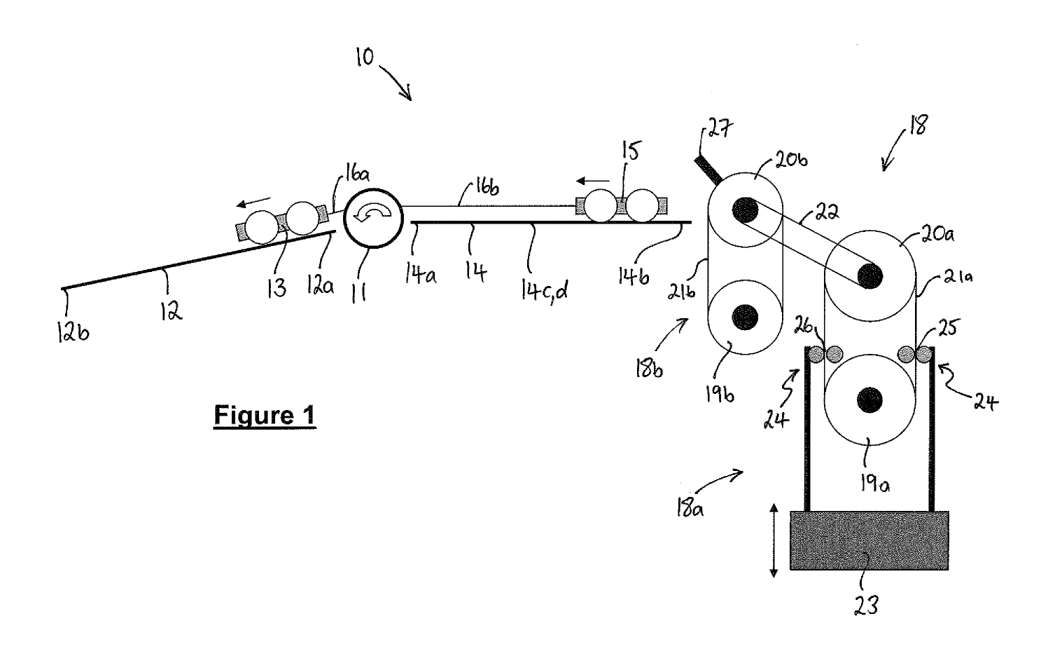

FIG. 1 is a schematic illustration of a side view of a drive assembly according to an embodiment of the present invention, with the second portion of the track arranged in the first position;

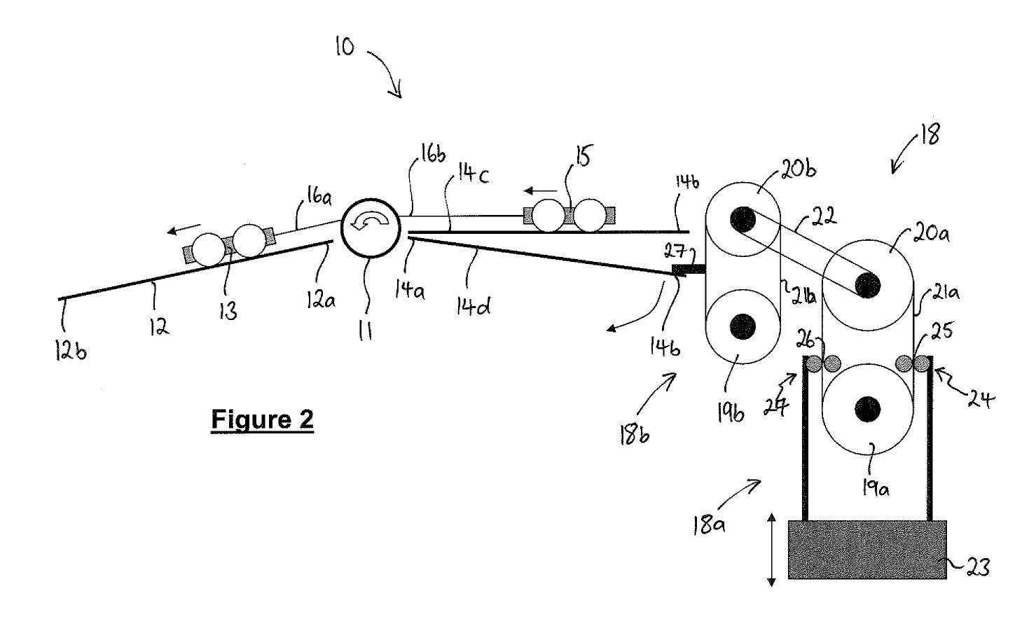

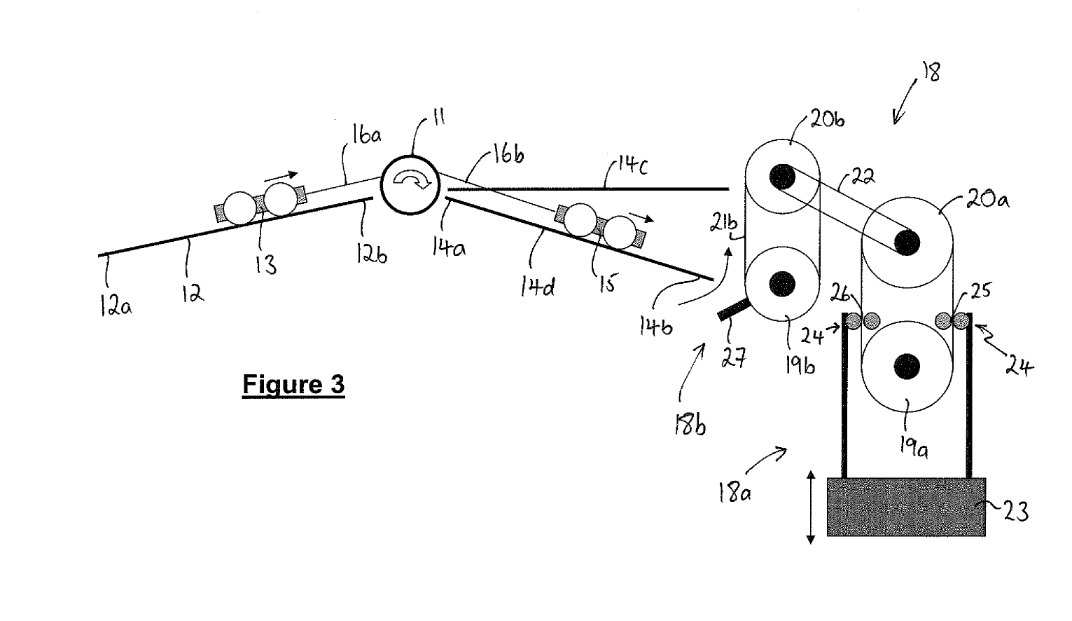

FIG. 2 is a schematic illustration of a side view of a drive assembly illustrated in FIG. 1 with the second portion of the track arranged intermediate the first and second position;

Referring to FIGS. 1 and 2 of the drawings, there is illustrated a drive assembly 10 according to an embodiment of the present invention for generating a driving force, such as driving torque associated with a drive shaft 11, to drive an electrical generator (not shown), for example to generate electricity. The assembly 10 comprises a first linear track 12 which is arranged to support a first vehicle 13, so that the first vehicle 13 can travel back and forth along the track 12, and a second linear track 14 which is arranged to extend in substantially the same plane as the first track 13, and which is arranged to support a second vehicle 15 so that the second vehicle 15 can travel back and forth along the second track 14.

The first and second tracks 12, 14 comprise a proximal end 12a, 14a and a distal end 12b, 14b, and the proximal end 12a, 14a of each track 12, 14 is disposed adjacent the drive shaft 11, such that the first and second tracks 12, 14 extend from opposite sides of the drive shaft 11. The drive shaft 11 is coupled to each vehicle 13, 15 via a respective belt, chain or tether 16a, 16b or similar and is arranged to rotate about an axis which extends substantially perpendicular to the tracks 12, 14, in dependence with the movement of the first and second vehicle 13, 15 along the respective tracks 12, 14.

The first track 12 is orientated in a substantially fixed orientation in which the track 12 is declined, such that the distal end 12b of the first track 12 is arranged at a lower vertical position than the proximal end 12a. The second track 14 comprises a first track portion 14c which is arranged in a substantially fixed horizontal orientation and a second track portion 14d, which is arranged to pivot about the proximal end 14a thereof, between a first position in which the second portion 14d is substantially coincident with the first portion 14c, and a second position in which the second portion 14d is declined to the horizontal, such that the distal end 14b of the second track portion 14d is arranged at a lower vertical position than the proximal end 14a of the second track portion 14d.

The second track portion 14d is biased to the first position by a coil spring (not shown) and is driven to the second position by a return drive 18. The return drive 18 comprises a first and second drive unit 18a, 18b which separately comprise a first sprocket 19a, 19b and a second sprocket 20a, 20b disposed above the first sprocket 19a, 19b. The first and second sprockets 19, 20 of each drive unit 18a, 18b are arranged to separately rotate about an axis which extends through a centre of the respective sprocket 19, 20, and the axis of rotation of each sprocket 19, 20 is arranged to be substantially parallel to each other, and substantially parallel to the rotational axis of the drive shaft 11. The first and second drive units 18a, 18b further comprises a belt or chain 21a, 21b which is arranged to separately extend around each sprocket 19, 20 of the respective unit 18a, 18b, and the second sprocket 20a, 20b of each unit 18a, 18b are further rotatably coupled by a transmission drive belt 22 which extends around the second sprockets 20a, 20b of each drive unit 18a, 18b.

The belt 21a of the first drive unit 18a is arranged to be driven by a floatation of buoyancy device 23. The floatation device 23 is arranged to float upon a fluid flow such as the surface of a river or upon the waves of the sea (not shown), and as such is arranged to rise and fall in accordance with the fluid flow. The floatation device 23 is coupled to the belt 21a of the first drive unit 18a by a coupling arrangement 24 which comprises a first and second coupler 25, 26, which are separately arranged to detachably couple with the belt 21a of the first drive unit 18a at opposite sides of the sprockets 19a, 20a of the first drive unit 18a. The first coupler 25 is arranged to clamp the belt 21a as the floatation device 23 rises to drive the belt 21a around the sprockets 19a, 20a, but to release the belt 21a as the floatation device 23 falls. In contrast, the second coupler 26 is arranged to clamp the belt 21 a as the floatation device 23 falls and release the belt 21a as the floatation device 23 rises. The coupling arrangement 24 thus provides for a continuous drive of the belt 21a of the first drive unit 18a in the same direction as the floatation device 23 rises and falls in the fluid flow.

The second drive unit 18b comprises a drive projection 27 disposed upon the belt 21b thereof, which is arranged to extend radially outwardly of the associated sprockets 19b, 20b, and is arranged to periodically engage with a distal end 14b of the second portion 14d of the second track 14 as the projection 27 moves around the second drive unit 18b. The projection 27 is arranged to engage with the distal end 14b of the second portion 14d in passing downward from the associated second sprocket 20b to the first sprocket 19b to reconfigure the second portion 14d from the first position to the second position. As the projection 27 passes around the first sprocket 19b however, the projection 27 is arranged to disengage from the second portion 14d, so that the second portion 14d can return to the first position under the bias of a coil spring (not shown), for example. In an alternative embodiment however, the skilled person will recognise, that the second portion 14d of the second track 14 may alternatively be biased to the second position and caused to return to the first position under the influence of the return drive 18.

The tethers 16a, 16b which couple the first and second vehicles 13, 15 to the drive shaft 11 are coupled at one end to the respective vehicle 13, 15 and at the other end to a respective first and second wheel (not shown). The first tether 16a is arranged to coil and uncoil from around the first wheel (not shown) which is rotatably coupled to the drive shaft 11 and the second tether 16b is arranged to coil and uncoil from around the second wheel (not shown) which is also rotatably coupled to the drive shaft 11. In use, the first tether 16a is initially coiled upon the first wheel (not shown) and the first vehicle 13 is arranged proximate the drive shaft 11, whereas the second tether 16b is substantially uncoiled from the second wheel (not shown) and the second vehicle 15 is disposed proximate the distal end 14b of the second track 14.

In order to generate a driving force, namely rotate the drive shaft 11, the first vehicle 13 is released from its initial drive location so that it can descend along the first track 12 toward a first idle location in which the tether 16a is fully unwound from the first wheel (not shown). As the first vehicle 13 travels along the first track 12, the first tether 16a becomes unwound from the first wheel (not shown) causing the first wheel (not shown) to rotate and thus drive the drive shaft 11. At the same time, the second wheel (not shown) rotates causing the second tether 16b to coil upon the second wheel (not shown) and thus the second vehicle 15 to travel along the first portion 14c of the second track 14 from a second idle position to a second drive position, in which the second tether 16b is substantially wound upon the second wheel (not shown).

As the second vehicle 15 reaches the second drive location, the second vehicle 15 is arranged to move off the first portion 14c onto the second portion 14d of the second track 14, which due to the projection 27 associated with the second drive unit 18b of the return drive 18 becomes reconfigured to the second position as the second vehicle 15 travels along the first portion 14c. The second vehicle 15 subsequently descends along the second portion 14d of the second track 14, causing the drive shaft 11 to rotate in the opposite direction and thus the first tether 16a to wind upon the first wheel (not shown) to return the first vehicle 13 to the first drive location. As the second vehicle 15 descends along the second portion 14d of the second track 14 however, the bias of the coil spring (not shown) gradually returns the second portion 14d to the first position, so that the vehicle 15 can return to the second idle position. Upon returning to the second idle position, the second vehicle 15 can then travel back along the first portion 14c of the second track 14 under the influence of the first vehicle 13 to continue to drive the drive shaft 11.

In a further embodiment which is not illustrated the first and second wheel (not shown) may be rotatably coupled to the drive shaft 11 via a respective gear (not shown) to cause the drive shaft 11 to rotate at a different rotational rate compared with the rotational rate of the first and second wheels (not shown).

In yet a further embodiment it is envisaged, that the first and second wheel (not shown) may be rigidly coupled to the drive shaft 11 and caused to rotate at the same rotational speed. In this embodiment, the first and second wheels (not shown) may comprise a different radius. For example, the radius of the first wheel (not shown) may be large compared with the second wheel (not shown), such that the extent to which the second vehicle 15 extends from the drive shaft 11 and thus the length of the second track 14, may be less than the first track 12. It is envisaged that this will reduce the torque required to lift the second portion 14d of the track and the second vehicle 15 to the first position, while maintaining a similar drive of the drive shaft 11.

From the foregoing therefore, it is evident that the drive assembly of the present invention provides for a simple yet effective means of generating a driving force and thus harvesting useful energy from renewable sources of energy.

1. A drive assembly for providing a driving force, the assembly comprising:
a first track along which a first vehicle is arranged to travel, the first track being declined in a first direction through a first declination;
a second track along which a second vehicle is arranged to travel, the second track comprising a first portion which extends in a second direction in a substantially horizontal configuration, and a second portion which is arranged to pivot with respect to the first track between a first position in which the second portion is substantially coincident with the first portion and a second position in which the second portion is declined in the second direction through a second declination;
a drive shaft coupled to the first and second vehicle, the drive shaft being arranged to rotate in dependence of the travel of the first and second vehicles along the respective tracks; wherein,
the first vehicle is arranged to travel along the first track between a first drive location and a first idle location to drive the shaft in a first direction and to cause the second vehicle to travel along the first portion of the second track between a second idle location and a second drive location; and,
the second vehicle is arranged to travel along the second portion from the second drive location to the second idle location to cause the drive shaft to rotate in a second direction and to cause the first vehicle to travel from the first idle location to the first drive location.

2. A drive assembly according to claim 1, wherein the second vehicle is arranged to extend from the second drive location when the second portion is arranged in the second position.

3. A drive assembly according to claim 1, wherein the second portion is arranged to pivot from the second position to the first position as the second vehicle travels along the second portion.

4. A drive assembly according to claim 1, wherein the second portion of the second track is biased to the first position.

5. A drive assembly according to claim 1, further comprising a return drive for reconfiguring the second portion from the first position to the second position.

6. A drive assembly according to claim 5, wherein the return drive is arranged to be driven by a fluid flow.

7. A drive assembly according to claim 5, wherein the return drive comprises a first drive unit and a second drive unit which separately comprise a belt or chain and sprocket arrangement and which are drivably coupled.

8. A drive assembly according to claim 7, wherein the return drive is arranged to be driven by a fluid flow, the belt or chain of the first drive unit is coupled to a floatation device via a coupling arrangement, and the floatation device is arranged to rise and fall in accordance with the fluid flow.

9. A drive assembly according to claim 8, wherein the floatation device is arranged to drive the belt or chain of the first drive unit during a rise and fall of the floatation device.

10. A drive assembly according to claim 8, wherein the coupling arrangement comprises a first coupler which is arranged to couple with the belt or chain of the first drive unit at a first side thereof, to drive the belt or chain as the floatation device rises with the fluid flow and to release the belt or chain as the floatation device falls with the fluid flow.

11. A drive assembly according to claim 10, wherein the coupling arrangement further comprises a second coupler which is arranged to couple with the belt or chain of the first drive unit at a second side thereof to drive the belt or chain as the floatation device falls with the fluid flow and to release the belt or chain as the floatation device rises with the fluid flow.

12. A drive assembly according to claim 7, wherein the second drive unit comprises a drive projection disposed on the belt or chain thereof which is arranged to engage the second portion to drive the second portion from the first position to the second position as the second vehicle travels from the second idle position to the second drive position, and to disengage from the belt or chain as the vehicle travels along the second portion from the second drive position to the second idle position.

13. A drive assembly according to claim 1, wherein the first and second vehicles are coupled to the drive shaft by a respective first and second belt, chain or tether.

14. A drive assembly according to claim 1, wherein the drive shaft comprises a first wheel which is rotatably coupled thereto, about which the first tether is arranged to retractably extend and a second wheel which is rotatably coupled thereto, about which the second tether is arranged to retractably extend.

15. A drive assembly according to claim 14, wherein the first and second wheels may be rotatably coupled to the drive shaft via a gear to provide for a variable rotation of the drive shaft compared with the rotation of the first and/or second wheels.

16. A drive assembly according to claim 1, wherein the first and second tracks extend in the same plane and the first and second directions are substantially opposite directions.

17. A drive assembly according to claim 1, wherein the drive shaft is arranged to drive an electric generator to generate electricity.

18. A method of generating electricity, the method comprising the use of the drive assembly according to claim 1.
